(19) United States
(12) Patent Application Publication
(10) Pub. No.: US 2009/0255475 A1
(43) Pub. Date: Oct. 15, 2009

(54) BIRD FEEDER

(75) Inventor: Derek James Black, York (GB)

Correspondence Address: BROOKS KUSHMAN P.C., 1000 TOWN CENTER, TWENTY-SECOND FLOOR, SOUTHFIELD, MI, 48075, US

(73) Assignee: CRANSWICK PET AND AQUATICS PLC, Kingston Upon Hull (GB)

(21) Appl. No.: 12/122,063

(22) Filed: May 16, 2008

(30) Foreign Application Priority Data
Apr. 11, 2008 (GB) 0806600.3

(51) Int. Cl. A01K 5/00; A01K 39/01

(52) U.S. Cl. 119/53

(57) ABSTRACT

A bird feeder (10) comprising a receptacle (12; 16) for retaining a quantity of bird feed, an aperture (24) in the receptacle (12; 16) through which, in use, feed can be dispensed, and means (28) for selectively adjusting a dimension of the aperture (24).

### CROSS-REFERENCE TO RELATED APPLICATIONS

This application claims the benefit of GB0806600.3 filed Apr. 11, 2008.

### BACKGROUND OF THE INVENTION

1. Field of the Invention

This invention relates to bird feeders, and in particular, to bird feeders for use with dry feeds, such as peanuts, sunflower seeds, maize, millet seeds etc.

2. Background Art

Bird feeders are widely available for dispensing dry feeds. Often, such feeders comprise a receptacle for retaining a quantity of dry feed and a dispenser, which enables birds to access the contents of the feeder. The receptacle and dispenser may sometimes be combined. For example, the receptacle may be manufactured entirely, or in part, from a wire mesh which enables birds to cling to and peck the feed through the holes in the mesh. Additionally or alternatively, the receptacle and dispenser may be separate items. For example, the receptacle may comprise a tube having an opening at the bottom thereof through which, under the effect of gravity, feed spills into a dish. Birds can then access the feed via the dish.

In many cases, a perch is conveniently provided to facilitate the birds' use of the feeder. A mounting means, e.g. a hanging hook or pole mount, is often also provided to facilitate locating the feeder at a desired location.

The type of dispenser used usually determines the feed types that are compatible with a particular feeder. Specifically, a dispenser having too large an opening or openings may not be able to control the egress of smaller-sized feeds (such as millet, ground cereals etc.), whereas a dispenser having too small an opening may block the egress of larger-sized feeds (for example, sunflower seeds, peanuts etc.). Thus, known bird feeders suffer the disadvantage of being limited to use in conjunction with certain types of feed.

Accordingly, if a user wishes feed different species of birds (which have different feed requirements/preferences) and/or maintain a year-round feeding regime (different dietary requirements being applicable at different times of year), then he/she must possess a range of feeders to do this. Known feeders are therefore unsatisfactory inasmuch as they can increase overall cost (e.g. more than one feeder may need to be purchased), introduce redundancy (e.g. certain feeders may not be used at different times of year) and add complexity.

### SUMMARY OF THE INVENTION

It is an object of the present invention to address one or more of the aforementioned problems and/or to provide an alternative and/or improved bird feeder.

According to a first aspect of the invention there is provided a dispenser for a bird feeder comprising an aperture adapted, in use, to communicate with the interior of a feed receptacle and means for selectively obstructing at least a portion of the aperture.

According to a second aspect of the invention there is provided a bird feeder comprising a receptacle for retaining a quantity of bird feed, an aperture in the receptacle through which, in use, feed can be dispensed, and means for selectively obstructing at least a portion of the aperture.

The means for selectively obstructing at least a portion of the aperture is preferably adjustable.

A plurality of apertures may be provided, which apertures may be identical. The means for obstructing at least a portion of the aperture preferably obstructs each aperture in substantially the same manner.

By selectively and/or adjustably obstructing the aperture the effective size of the aperture can be varied thereby controlling the egress of feed through the or each aperture.

The means for selectively obstructing the aperture may comprise a hit-and-miss closure. The hit and miss closure, where provided, can take various forms although it may generally comprise first and second relatively moveable members. In one embodiment, the first relatively moveable member may comprise an aperture and the second relatively moveable member may comprise an obstructing means (e.g. one or more bars, a wire mesh, a retractable cone adapted to engage the aperture) that can be positioned to least partially obstruct the aperture of the first member. The effective dimension of the aperture, i.e. its degree of communication with the interior of the feed receptacle, its unobstructed area, its width or height, can be adjusted by moving the first and second members relative to one another to adjust the amount of obstruction of the aperture by the obstructing means.

In another embodiment, the first and second relatively moveable members may each comprise an opening, which openings can be arranged to at least partially overlap thereby defining the aperture. The effective dimension of the aperture, i.e. its degree of communication with the interior of the feed receptacle, its unobstructed area, its width or height, can be adjusted by moving the first and second members relative to one another to adjust the amount of overlapping of their respective openings.

The first and second members can be axially and/or rotationally and/or slidably moveable relative to one another. Additionally or alternatively, the first and second members may be screw-threadedly connected to one another. Conveniently, by screw-threadedly connecting the first and second members to one another, they can be relatively moveable both axially and rotationally, and in addition, be connected. A detent means may be provided so that the first and second members can be easily moved to preset relative positions. In the case of a bird feeder, the detent means could provide set positions corresponding to effective aperture dimensions that permit certain types of feed to pass through the aperture. For example, the detent means may have three pre-set positions corresponding to aperture dimensions that allow millet, peanuts and sunflower seeds to pass through the aperture. The detent means is preferably labelled accordingly (e.g. “1”, “2”, “3”; or “millet”, “peanut”, “sunflower seed”). Any number of pre-set positions may be provided.

Conveniently, one of the first or the second members can be substantially immovable relative to the feed receptacle, which means that only the other of the members needs to be moved to affect effective aperture dimension adjustment. More conveniently still, the substantially immovable member may comprise, or be integrally formed with, the feed receptacle.

One of the first and/or second members may comprise, or form part of, a closure means for the feed receptacle, such as an end cap.

The feed receptacle may be tubular. The intended lower end of the tube is preferably closed. The feed receptacle may manufactured of, or comprise, wire mesh, however, any reticulated, perforated or apertured material may be used.

The aperture may be located at or towards an intended lower end of the feed receptacle so that the feed is gravity fed, i.e. dispensed automatically.

A feed dish may be conveniently located below the aperture to collect dispensed feed. A perch may additionally be provided adjacent the aperture to facilitate the birds' access thereto. An edge of the feed dish may form a convenient perch for the birds, and may thus be provided with a grip portion, for example a roughened surface, a rail or a suitably profiled edge.

A rain cover may also be provided to protect the feed from the elements, as too may a hanging means to facilitate locating the feeder at a desired location.

### BRIEF DESCRIPTION OF THE DRAWINGS

Preferred embodiments of the invention shall now be described, by way of example only, with reference to the accompanying drawings in which:

FIG. 1 is a perspective view of an embodiment of bird feeder in accordance with the invention;

FIG. 2 is a perspective view of the dispenser of FIG. 1 in accordance with the first aspect of the invention;

FIGS. 3 and 4 are schematic partial cross-sections of variants of a bird feeder according to the invention showing the plug member removed and screwed-in, respectively;

FIG. 5 is a side elevation of the bird feeder of FIG. 1 with a hanging loop and rain hood fitted; and

FIG. 6 is a perspective view from below of the plug member of FIGS. 3 and 4.

### DETAILED DESCRIPTION OF THE PREFERRED EMBODIMENT(S)

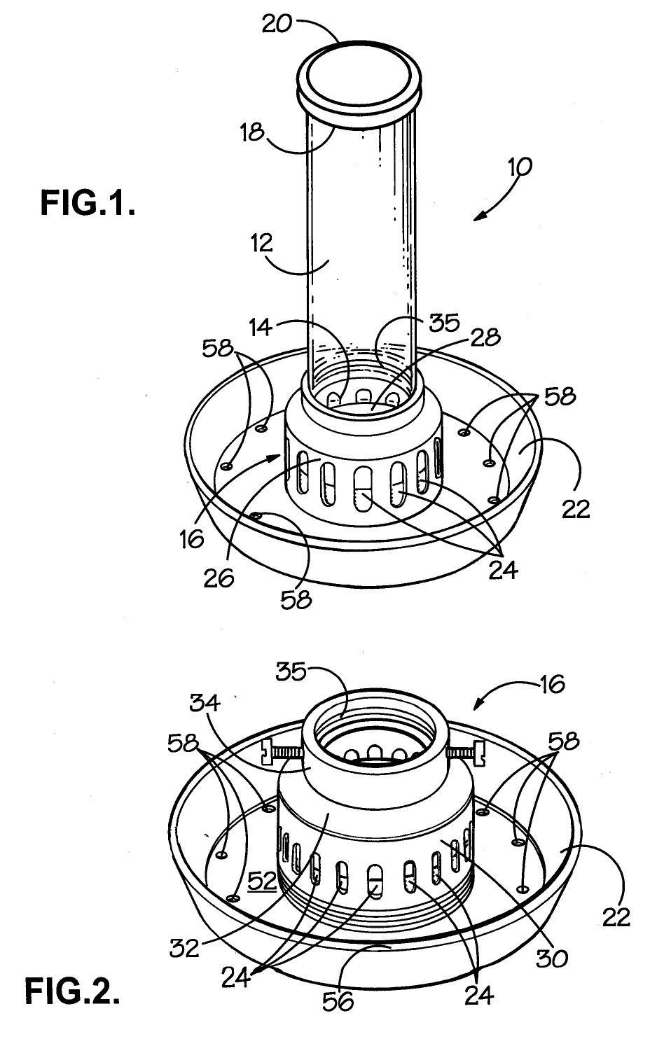

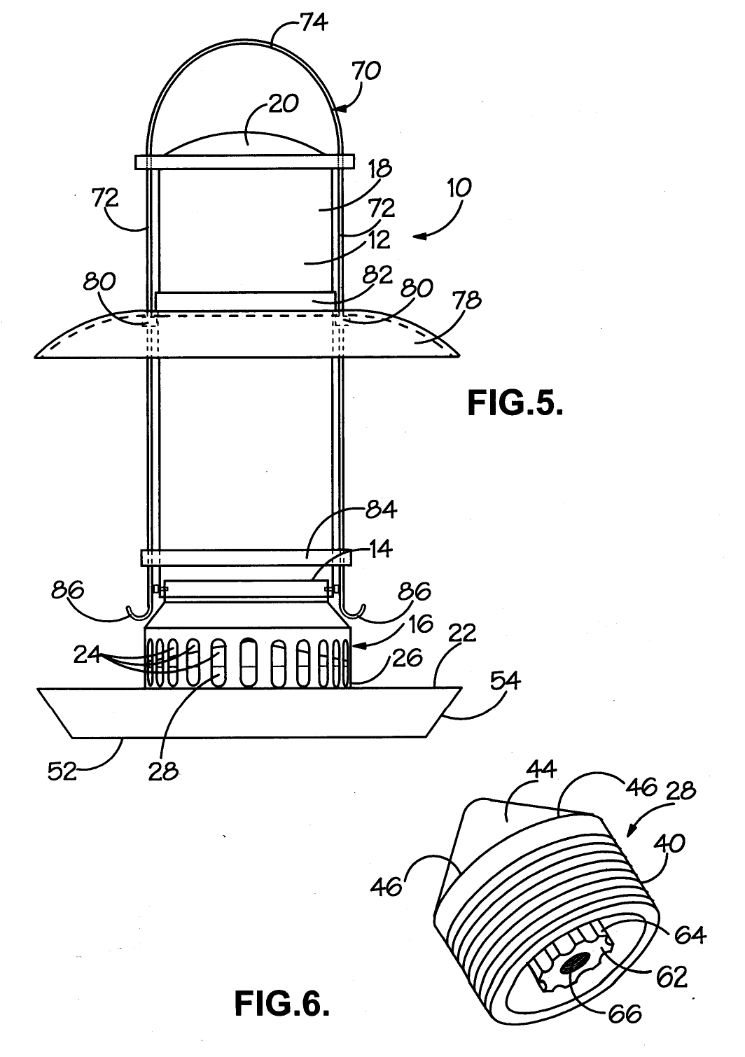

In FIGS. 1 and 5, a bird feeder 10 comprises a feed receiving tube 12 that communicates, via its open lower end 14, with a dispenser 16. At its upper end 18, the feed receiving tube 12 is closed by a domed end cap 20. An annular feed dish 22 forming part of the dispenser 16 catches feed (not shown) as it is dispensed and presents it for birds to eat. The dispenser 16 comprises a number of slotted elongate apertures 24 extending generally vertically in use, through which feed can spill out of the receiving tube 12 onto the feed dish 22. Birds can perch on the feed dish 22 to eat feed that has spilled into it through the apertures 24.

In FIG. 2 the detail of the dispenser 16 can be seen more clearly. The dispenser 16 comprises a generally tubular upper member 26 in the main body portion 30 of which the apertures 24 are formed and a generally cylindrical plug member 28. The upper member 26 is internally threaded and screw-threadedly receives externally threaded plug member 28 whereby relative rotation of the two members 26, 28 causes the plug member 28 to move axially within the upper member 26.

The plug 28 can be screwed into, or out of, the upper member 26 so that its upper edge 46 overlaps the slotted apertures 24 in the wall of the upper member 26 by a desired amount. In the embodiments shown, by screwing the plug 28 further into the upper member 26, the effective vertical height and, hence, the unobstructed area of the apertures 24, is reduced. Conversely, by unscrewing the plug 28 to retract it from within the upper member 26, the effective vertical height and, hence, the unobstructed area of the apertures 24 is increased. Thus, any size aperture ranging from “fully open” (i.e. the apertures 24 are unobstructed) to “fully closed” (i.e. the apertures 24 are completely blocked off) can be selected. Thus, the rate at which feed spills through the apertures 24 can be controlled and/or the type of feed spilling through the apertures 24 can be selected on the basis of size (i.e. whether or not it will fit through the apertures 24).

The plug 28 also comprises a frustoconical upper surface 44 that encourages, in use, feed located above it in the feed receiving tube 12 to move outwardly towards the slotted apertures 24 in the upper member 26.

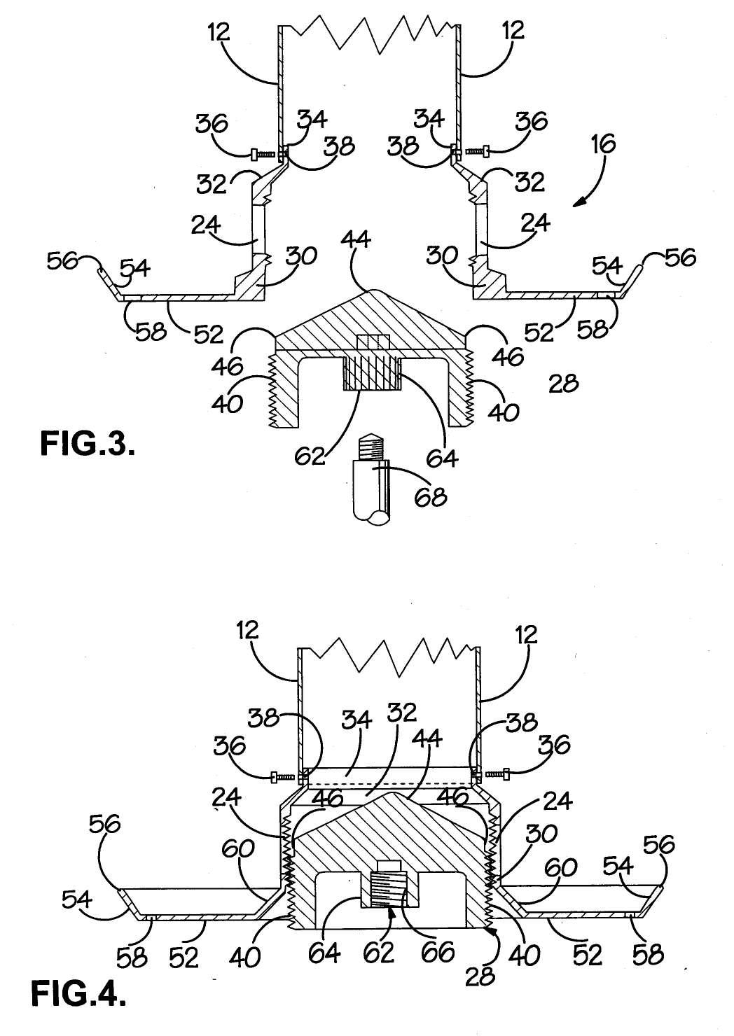

The upper member 26 comprises a tubular main body portion 30, and at its upper end, an integrally formed, frusto-conical shoulder portion 32 leading to a tubular neck portion 34 of smaller diameter than the main body portion 30. In FIGS. 1 and 5, the internal diameter of the neck portion 34 is selected so as to be a friction fit around a specified removable feed receiving tube 12. In FIGS. 1 and 2, it can be seen that the interior wall of the neck portion 34 is provided with an inwardly projecting lip 35 against which the bottom edge of the feed receiving tube 12 abuts. In FIGS. 3, 4 and 5, the opposite is true, i.e. feed receiving tube 12 is a frictionfit around the neck portion 43.

In both cases, a pair of diametrically opposed retaining screws 36 pierce and pass through the side wall of the feed receiving tube 12 and also into pre-tapped locating holes 38 in the neck portion 34. Thus, the feed receiving tube 12 is securely but releasably connected to the neck 34 of the dispenser 16.

In FIGS. 1 to 5, an annular feed dish 22 forming part of the dispenser 16 is provided below the apertures 24 to catch feed as it spills out of the apertures 24. The feed dish 22 has a generally planar, annular base 52 and an outwardly flared frusto-conical rim 54 extending upwardly therefrom. The upper edge of the rim 56 of the side wall 54 provides a convenient perch for birds. Six drainage holes 58 are provided in the base 52 to allow rainwater to drain away, thus reducing the risk of spoiling feed in the feed dish 22. In the embodiment shown in FIG. 4, the base 52 of the feed dish also comprises an inner frusto-conical wall portion 60 that slopes downwardly away from the apertures 24 towards the planar base wall 52 and which helps to direct feed away from the dispenser 16 to prevent it from piling up and blocking the apertures 24 and to make it easier for smaller birds to reach from the perch 56.

In FIGS. 3, 4 and 6, it can be seen that the underside of the plug 28 comprises a recessed central boss 62 having an external grip portion 64 to facilitate screwing the plug 28 into, and out of, the upper member 26. An internally threaded blind hole 66 is also provided for screw-threadedly attaching the feeder 10 to a mounting pole 68.

Finally, FIG. 5 shows the feeder 10 fitted with a hanging loop 70. The hanging loop 70 comprises a length of wire bent so as to comprise a pair of generally straight, spaced-apart, vertical limbs 72 connected to one another at their upper ends by a generally inverted u-shaped portion 74. The inverted u-shaped portion 74 provides a convenient hanging loop for the feeder 10.

The vertical limbs 72 slidably pass through through holes 76 in the periphery of the end cap 20 to enable the end cap 20 to be lifted off the upper rim of the feed receiving tube 20 to facilitate filling thereof.

The feeder 10 also comprises a domed, ring-shaped rain guard 78 that overhangs the feed dish 22 to protect feed therein from the elements. The rain guard 78 is slidably located on the vertical limbs 72 of the hanging loop 70 and its height above the feed dish 22 can be adjusted by moving friction-fitting sliding collars 80, 82 located about the vertical limbs 72 and tube 12, respectively. By moving the rain guard 78 closer to the feed dish 22, larger birds can be discouraged from feeding therefrom, if desired.

The hanging loop 70 is prevented from sliding off the feed retaining tube 12 by a further collar 84 that grips the tube 12 and which engages bent ends 86 of the hanging loop.

The feed receiving tube 12 is manufactured of transparent plastic to enable birds to identify its contents and also to enable a user to determine how much feed is present. The dispenser 16 is manufactured from cast aluminium for reasons of durability and to increase the weight, and lower the centre of gravity, of the feeder 10, which stabilises it in strong winds—especially where the feeder 10 is hung from the hanging loop 70 or is simply placed on a flat surface.

The invention is not limited to the details of the foregoing embodiments. For example, the feed receiving tube may be formed entirely, or in part, from a reticulated or apertured material to enable birds to peck food directly from the tube.

Instead of, or in addition to, the construction described above, the dispenser may comprise a sliding collar fitted around the feed receiving tube in an apertured region thereof. In such a case, appropriate positioning of the collar relative to the apertures could enable the unobstructed area of the apertures to be varied.

The rain guard and feed dish are optional and may be omitted. Any reference herein to materials of construction is not intended to be limiting where alternative materials may be used, e.g. plastics for any component of the feeder 10.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A dispenser for a bird feeder comprising an aperture adapted, in use, to communicate with the interior of a feed receptacle and means for selectively obstructing at least a portion of the aperture.

2. A dispenser as claimed in claim 1, wherein the means for selectively adjusting at least a portion of the aperture is adjustable.

3. A dispenser or bird feeder as claimed in claim 1, comprising a plurality of apertures.

4. A dispenser as claimed in claim 4, wherein the means for obstructing at least a portion of the aperture obstructs each aperture in substantially the same manner.

5. A dispenser as claimed in claim 1, wherein the means for selectively obstructing the or each aperture comprises a hit-and-miss closure.

6. A dispenser as claimed in claim 5, wherein the hit-and-miss closure comprises first and second relatively moveable members, the first member comprising an aperture therein and the second member comprising an obstructing means for at least partially obstructing the aperture of the first member, wherein a dimension of the aperture is adjustable by moving the first and second members relative to one another to adjust the amount of obstruction of the aperture by the obstructing means.

7. A dispenser as claimed in claim 5, wherein the hit-and-miss closure comprises first and second relatively moveable members, the first and second members each comprising an opening therein that can be relatively arranged to at least partially overlap thereby defining the aperture, wherein a dimension of the aperture is adjustable by moving the first and second members relative to one another to adjust the amount of overlapping of their respective openings.

8. A dispenser as claimed in claim 5, wherein the hit-and-miss closure comprises first and second relatively movable members, the relative movement comprising any one or more of the group comprising: axial movement; rotational movement; sliding movement; and helical movement.

9. A dispenser as claimed in claim 5, wherein the hit-and-miss closure comprises first and second members that are screw-threadedly connected to one another.

10. A dispenser or bird feeder as claimed in 5, wherein the hit and miss closure comprises a detent means.

11. A bird feeder comprising a receptacle for retaining a quantity of bird feed, an aperture in the receptacle through which, in use, feed can be dispensed, and means for selectively obstructing at least a portion of the aperture.

12. A bird feeder as claimed in claim 11, wherein the means for selectively adjusting at least a portion of the aperture is adjustable.

13. A bird feeder as claimed in claim 11, comprising a plurality of apertures.

14. A bird feeder as claimed in claim 11, wherein the means for selectively obstructing the or each aperture comprises a hit-and-miss closure.

15. A bird feeder as claimed in claim 14, wherein the hit and miss closure comprises first and second relatively moveable members, the first member comprising an aperture therein and the second member comprising an obstructing means for at least partially obstructing the aperture of the first member, wherein a dimension of the aperture is adjustable by moving the first and second members relative to one another to adjust the amount of obstruction of the aperture by the obstructing means.

16. A bird feeder as claimed in claim 14, wherein the hit and miss closure comprises first and second relatively moveable members, the first and second members each comprising an opening therein that can be relatively arranged to at least partially overlap thereby defining the aperture, wherein a dimension of the aperture is adjustable by moving the first and second members relative to one another to adjust the amount of overlapping of their respective openings.

17. A bird feeder as claimed in claim 14, wherein the hit and miss closure comprises first and second relatively movable members, the relative movement comprising any one or more of the group comprising: axial movement; rotational movement; sliding movement; and helical movement.

18. A dispenser or bird feeder as claimed in claim 11, wherein the feed receptacle is manufactured of, or comprises, wire mesh.

19. A dispenser or bird feeder as claimed in claim 11, wherein the aperture is located at, or towards, an intended lower end of the feed receptacle.

20. A dispenser or bird feeder as claimed in claim 11, further comprising means located below the aperture for receiving and presenting feed which has passed through the or each aperture.
